(19) United States
(12) Patent Application Publication
(10) Pub. No.: US 2021/0098014 A1
(43) Pub. Date: Apr. 1, 2021

(54) NOISE ELIMINATION DEVICE AND NOISE ELIMINATION METHOD

(71) Applicant: MITSUBISHI ELECTRIC CORPORATION, Tokyo (JP)

(72) Inventor: Nobuaki TANAKA, Tokyo (JP)

(73) Assignee: MITSUBISHI ELECTRIC CORPORATION, Tokyo (JP)

(21) Appl. No.: 16/635,101

(22) PCT Filed: Sep. 7, 2017
(86) PCT No.: PCT/JP2017/032311

§ 371 Date: Jan. 29, 2020

(51) Int. Cl. G10L 21/0216; G10K 11/34; G10K 11/178; H04R 1/40

(52) U.S. Cl. CPC G10L 21/0216; G10K 11/34; G10K 11/17813; H04R 1/406; G10L 2021/02087; H04R 2499/13; G10K 2210/1282; G10L 2021/02166; G10K 2200/10

(57) ABSTRACT

It is provided with: a target sound vector selecting unit for selecting, from steering vectors acquired in advance and indicating arrival directions of sound with respect to a microphone array including two or more acoustic sensors, a target sound steering vector indicating an arrival direction of target sound; an interference sound vector selecting unit for selecting, from the steering vectors acquired in advance, an interference sound steering vector indicating an arrival direction of interference sound other than the target sound; and a signal processing unit for acquiring, on the basis of two or more observation signals obtained from the microphone array, the target sound steering vector, and the interference sound steering vector, a signal obtained by eliminating the interference sound from the observation signals.

### TECHNICAL FIELD

The present invention relates to a technique for eliminating noise other than voice coming from a desired direction.

### BACKGROUND ART

Conventionally, there is a noise elimination technique for enhancing voice coming from a desired direction and eliminating noise other than the voice by using a sensor array consisting of multiple acoustic sensors (for example, microphones) and performing predetermined signal processing on an observation signal obtained from each of the sensors.

By the noise elimination technique described above, for example, it is possible to clarify voice that is difficult to be caught due to noise generated from equipment such as air conditioning equipment, or to extract only voice of a desired speaker when multiple speakers speak at the same time. In this way, the noise elimination technique can not only make it easy for people to listen to voice, but also improve noise robustness against noise of voice recognition processing by eliminating noise as preprocessing of the voice recognition processing.

Various techniques for forming directivity by signal processing using a sensor array have been conventionally disclosed. For example, in Non-Patent Literature 1, there has been disclosed a technique for eliminating noise other than target sound by statistically calculating a linear filter coefficient that minimizes an average gain of an output signal and thus performing linear beamforming, using a steering vector indicating an arrival direction of target sound measured or generated in advance, and under a condition that does not change a gain of voice coming from the arrival direction of the target sound.

However, in the technique disclosed in Non-Patent Literature 1 described above, the linear filter coefficient for appropriately eliminating the noise is calculated, so that an observation signal of interference sound needs a certain length. This is because, since information on a position of an interference sound source is not given in advance, it is necessary to estimate the position of the interference sound source from the observation signal. As a result, the technique disclosed in Non-Patent Literature 1 has a problem that sufficient noise elimination processing performance cannot be obtained immediately after the start of noise elimination processing.

In order to solve this problem, in a sound signal processing device described in Patent Literature 1, noise is eliminated by generating a steering vector indicating an arrival direction of target sound in advance, calculating a similarity in phase difference between sensors calculated from an observation signal for each time-frequency and phase difference between sensors calculated from the steering vector in the arrival direction of the target sound, and applying time-frequency masking that passes only a time-frequency spectrum with a high similarity to the observation signal.

### CITATION LIST

### Patent Literatures

Patent Literature 1: JP 2012-234150 A

### NON-PATENT LITERATURES

Non-Patent Literature 1: Futoshi Asano, “Sound Array Signal Processing Sound Source Localization/Tracking and Separation”, Corona Publishing Co., Ltd., 2011, pages 86-88

### SUMMARY OF INVENTION

### Technical Problem

In the sound signal processing device described in Patent Literature 1 described above, since an output signal is determined only by the observation signal at that moment without using statistical calculation, stable noise elimination performance can be obtained immediately after the start of noise elimination processing.

However, in the sound signal processing device described in Patent Literature 1, since only the arrival direction of the target sound is used as information regarding an arrival direction of a sound source to extract the target sound, a position where an interference sound source exists with respect to a target sound source is not considered. Therefore, in the sound signal processing device described in Patent Literature 1, when the arrival direction of the target sound and an arrival direction of interference sound are close to each other, when a difference in phase difference between the target sound and the interference sound observed by a sensor array is small, or the like, there is a problem that the noise elimination performance is lowered.

This is because, in time-frequency masking in a low frequency region where the phase difference between the target sound and the interference sound is unlikely to occur, there is a high possibility that a time-frequency spectrum of the interference sound is erroneously passed, and it is difficult to obtain a high-quality output signal.

The present invention has been made to solve the above problems, and objects thereof are to achieve good noise elimination performance even when an arrival direction of target sound and an arrival direction of interference sound are close to each other and to achieve stable noise elimination performance immediately after noise elimination processing is started.

### Solution to Problem

A noise elimination device according to the present invention includes: a target sound vector selecting unit for selecting, from steering vectors acquired in advance and indicating arrival directions of sound with respect to a sensor array including two or more acoustic sensors, a target sound steering vector indicating an arrival direction of a target sound; an interference sound vector selecting unit for selecting, from the steering vectors acquired in advance, an interference sound steering vector indicating an arrival direction of interference sound other than the target sound; and a signal processing unit for acquiring, on a basis of two or more observation signals obtained from the sensor array, the target sound steering vector selected by the target sound vector selecting unit, and the interference sound steering vector selected by the interference sound vector selecting unit, a signal obtained by eliminating the interference sound from the observation signals.

### Advantageous Effects of Invention

According to the present invention, even when an arrival direction of target sound and an arrival direction of interference sound are close to each other, good noise elimination performance can be achieved, and stable noise elimination performance can be achieved immediately after noise elimination processing is started.

### BRIEF DESCRIPTION OF DRAWINGS

FIG. 1 is a block diagram showing a configuration of a noise elimination device according to a first embodiment.

FIGS. 2A and 2B are diagrams illustrating a hardware configuration example of the noise elimination device according to the first embodiment.

FIG. 3 is a flowchart showing an operation of a signal processing unit of the noise elimination device according to the first embodiment.

FIG. 4 is a flowchart showing an operation of a signal processing unit of a noise elimination device according to a second embodiment.

FIG. 5 is a diagram showing an application example of the noise elimination device according to the first embodiment or the second embodiment.

FIG. 6 is a diagram showing an application example of the noise elimination device according to the first embodiment or the second embodiment.

### DESCRIPTION OF EMBODIMENTS

Hereinafter, in order to explain the present invention in more detail, embodiments for carrying out the present invention will be described with reference to the accompanying drawings.

Further, in the embodiments for carrying out the present invention, a nondirectional microphone is used as a specific example of an acoustic sensor, and a sensor array is described using a microphone array. Note that the acoustic sensor is not limited to the nondirectional microphone and is also applicable to a directional microphone or an ultrasonic sensor, for example.

### First Embodiment

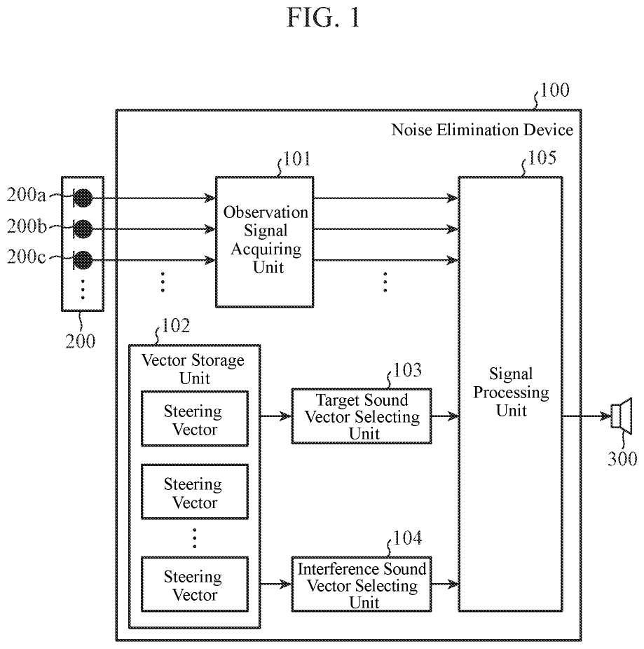

FIG. 1 is a block diagram showing a configuration of a noise elimination device 100 according to a first embodiment.

The noise elimination device 100 includes an observation signal acquiring unit 101, a vector storage unit 102, a target sound vector selecting unit 103, an interference sound vector selecting unit 104, and a signal processing unit 105.

Further, a microphone array 200 including a plurality of microphones 200 a, 200b, 200c, . . . and an external device 300 are connected to the noise elimination device 100.

In the noise elimination device 100, on the basis of observation signals observed by the microphone array 200 and steering vectors selected and output by the target sound vector selecting unit 103 and the interference sound vector selecting unit 104 among steering vectors stored in the vector storage unit 102, the signal processing unit 105 generates an output signal obtained by eliminating noise from the observation signals, and outputs the output signal to the external device 300.

The observation signal acquiring unit 101 performs A/D conversion of the observation signals observed by the microphone array 200 and converts them into digital signals. The observation signal acquiring unit 101 outputs the observation signals converted into the digital signals to the signal processing unit 105.

The vector storage unit 102 is a storage area for storing a plurality of steering vectors measured or generated in advance. The steering vector is a vector corresponding to a sound arrival direction viewed from the microphone array 200. The steering vector stored in the vector storage unit 102 is a spectrum in which frequency spectra obtained by discrete Fourier transform of impulse responses in certain directions measured in advance using the microphone array 200 are divided and normalized by a frequency spectrum of an arbitrary microphone. In other words, when the number of microphones constituting the microphone array 200 is M, a complex vector â(ω) shown in the following equation (1) constituted by using frequency spectra S₁(ω) to S_{M}(ω) obtained by discrete Fourier transform of impulse responses measured by the M microphones is set as a steering vector. In the equation (1), ω represents a discrete frequency, and T represents a vector transposition.

$$a ( ω ) = {( \begin{matrix}1 & \frac{{S}_{2} ( ω )}{{S}_{1} ( ω )} & ⋯ & \frac{{S}_{M} ( ω )}{{S}_{1} ( ω )}\end{matrix} )}^{T} \qquad ( 1 )$$

Note that the steering vector does not necessarily have to be obtained by the same method as the above-described equation (1). For example, in the above equation (1), normalization is performed by the frequency spectrum S₁(ω) corresponding to the first of the M microphones, but normalization may be performed by a frequency spectrum corresponding to a microphone other than the first microphone. Further, the frequency spectra of the impulse responses can be used as they are as steering vectors without normalization. However, in the following description, it is assumed that the steering vector is normalized by the frequency spectrum corresponding to the first microphone as shown in the equation (1).

The target sound vector selecting unit 103 selects, from the steering vectors stored in the vector storage unit 102, a steering vector indicating a direction in which desired voice arrives (hereinafter referred to as a target sound steering vector). The target sound vector selecting unit 103 outputs the selected target sound steering vector to the signal processing unit 105. The direction in which the target sound vector selecting unit 103 selects the target sound steering vector is set on the basis of, for example, a direction in which desired voice designated on the basis of a user input arrives.

The interference sound vector selecting unit 104 selects, from the steering vectors stored in the vector storage unit 102, a steering vector in a direction in which noise to be eliminated arrives (hereinafter referred to as an interference sound steering vector). The interference sound vector selecting unit 104 outputs the selected interference sound steering vector to the signal processing unit 105. The direction in which the interference sound vector selecting unit 104 selects the interference sound steering vector is set on the basis of, for example, a direction in which noise to be eliminated designated on the basis of a user input arrives.

However, in a situation where a positional relationship between a target sound source and an interference sound source does not change, the target sound vector selecting unit 103 can continue to output a steering vector in an arrival direction of a single target sound, and the interference sound vector selecting unit 104 can continue to output a steering vector in an arrival direction of a single interference sound.

When there is a plurality of target sound sources and interference sound sources, the target sound vector selecting unit 103 may output a plurality of target sound steering vectors, and the interference sound vector selecting unit 104 may output a plurality of interference sound steering vectors. In this case, since the plurality of target sound sources exists, the noise elimination device 100 may output a plurality of target sounds obtained by eliminating noise as a plurality of output signals.

However, in the following, for simplification of description, it is assumed that the target sound vector selecting unit 103 and the interference sound vector selecting unit 104 select and output a single target sound steering vector and a single interference sound steering vector, respectively. In other words, the output signal of the signal processing unit 105 is a target sound signal obtained by eliminating a single noise. Also, hereinafter, the target sound steering vector selected and output by the target sound vector selecting unit 103 is described as a target sound steering vector a_{trg}(ω). Similarly, the interference sound steering vector selected and output by the interference sound vector selecting unit 104 is described as an interference sound steering vector a_{dst}(ω).

By using the observation signals obtained from the observation signal acquiring unit 101, the target sound steering vector obtained from the target sound vector selecting unit 103, and the interference sound steering vector obtained from the interference sound vector selecting unit 104, the signal processing unit 105 outputs a signal obtained by eliminating noise other than target sound as an output signal. Here, as an example of the signal processing unit 105, a mounting method by linear beamforming is described.

In the following, the signal processing unit 105 performs discrete Fourier transform on signals observed by the M microphones to acquire time-frequency spectra X₁(ω, τ) to X_{M}(ω, τ). Here, i represents a discrete frame number. The signal processing unit 105 obtains, on the basis of the following equation (2), a time-frequency spectrum Y(ω, τ) of an output signal by linear beamforming. x(ω, τ) in the equation (2) is a complex vector in which the time-frequency spectra X₁(ω, τ) to X_{M}(ω, τ) are arranged as shown in the equation (3). In addition, w(ω) in the equation (2) is a complex vector in which linear filter coefficients in the linear beamforming are arranged. Further, H in the equation (2) represents a complex conjugate transpose of a vector or a matrix.

Y(ω, τ)=w(ω)^{H}x(ω, τ) (2)

x(ω, τ)=(X₁(ω, τ), . . . , X_{M}(ω, τ)) (3)

When the linear filter coefficient w(ω) is appropriately given in the above-described equation (2), the signal processing unit 105 acquires the time-frequency spectrum Y(ω, τ) obtained by eliminating noise. Here, a condition to be satisfied by the linear filter coefficient w(ω) is a condition for securing a gain of the target sound and setting a gain of the interference sound to zero. In other words, after forming directivity in the arrival direction of the target sound, the linear filter coefficient w(ω) forms a blind spot in the arrival direction of the interference sound. This is equivalent to the linear filter coefficient w(ω) satisfying the following equations (4) and (5).

w(ω)^{H}a_{trg}(ω)=1 (4)

w(ω)^{H}a_{dst}(ω)=0 (5)

The equations (4) and (5) described above can be described as an equation (6) using a matrix. Note that A in the equation (6) is a complex matrix represented by the following equation and r in the equation (6) is a vector represented by the following equation (8).

A^{H}w(ω)=r (6)

A=(a_{trg}(ω)a_{dst}(ω)) (7)

r=(1 0)^{T} (8)

The linear filter coefficient w(ω) satisfying the above-described equation (6) is obtained using the following equation (9).

w(ω)=A⁺r (9)

A⁺ in the above equation (9) is a Moore-Penrose pseudo inverse matrix of the matrix A. The signal processing unit 105 calculates the above-described equation (2) using the linear filter coefficient w(ω) obtained by the above-described equation (9). As a result, the signal processing unit 105 acquires the time-frequency spectrum Y(ω, τ) obtained by eliminating the noise. The signal processing unit 105 performs discrete inverse Fourier transform on the acquired time-frequency spectrum Y(ω, τ), reconstructs a time waveform, and outputs it as a final output signal.

The external device 300 is a device configured with a speaker unit, or a storage medium such as a hard disk or a memory, for example, and outputs the output signal output from the signal processing unit 105. When the external device 300 is configured with a speaker unit, the output signal is output as a sound wave from the speaker unit. Further, when the external device 300 is configured with a storage medium such as a hard disk or a memory, the storage medium stores the output signal as digital data in the hard disk or the memory.

Next, a hardware configuration example of the noise elimination device 100 will be described.

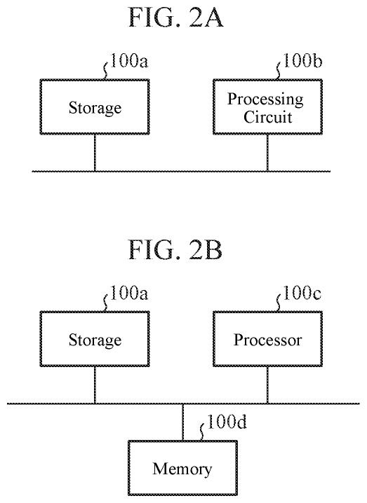

FIGS. 2A and 2B are diagrams illustrating the hardware configuration examples of the noise elimination device 100.

The vector storage unit 102 in the noise elimination device 100 is implemented by a storage 100a. Further, functions of the observation signal acquiring unit 101, the target sound vector selecting unit 103, the interference sound vector selecting unit 104, and the signal processing unit 105 in the noise elimination device 100 are implemented by a processing circuit. In other words, the noise elimination device 100 includes the processing circuit for realizing the above functions. The processing circuit may be a processing circuit 100b which is dedicated hardware as shown in FIG. 2A, or may be a processor 100c for executing a program stored in a memory 100d as shown in FIG. 2B.

As shown in FIG. 2A, when the observation signal acquiring unit 101, the target sound vector selecting unit 103, the interference sound vector selecting unit 104, and the signal processing unit 105 are dedicated hardware, the processing circuit 100b corresponds to, for example, a single circuit, a composite circuit, a programmed processor, a processor programmed in parallel, an application specific integrated circuit (ASIC), a field-programmable gate array (FPGA), or a combination thereof. Each of the functions of the observation signal acquiring unit 101, the target sound vector selecting unit 103, the interference sound vector selecting unit 104, and the signal processing unit 105 may be implemented by the processing circuit, or may be implemented by one processing circuit by combining the functions of the units.

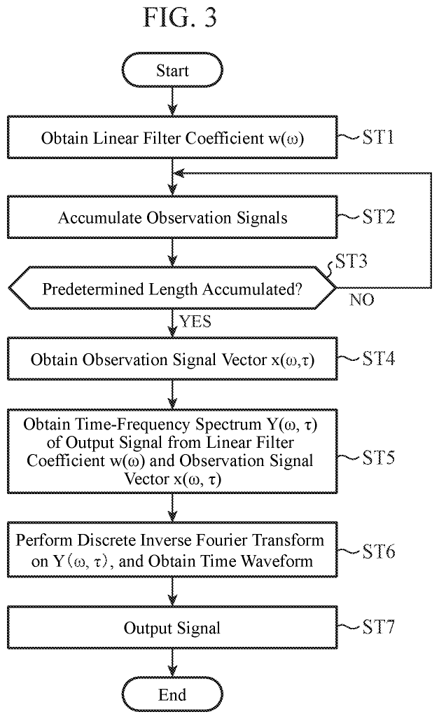

As shown in FIG. 2B, when the observation signal acquiring unit 101, the target sound vector selecting unit 103, the interference sound vector selecting unit 104, and the signal processing unit 105 are the processor 100c, the functions of the units are implemented by software, firmware, or a combination of the software and the firmware. The software or firmware is described as a program and stored in the memory 100d. The processor 100c implements the functions of the observation signal acquiring unit 101, the target sound vector selecting unit 103, the interference sound vector selecting unit 104, and the signal processing unit 105 by reading and executing the program stored in the memory 100d. In other words, when the observation signal acquiring unit 101, the target sound vector selecting unit 103, the interference sound vector selecting unit 104, and the signal processing unit 105 are provided with the memory 100d for storing a program in which steps shown in FIG. 3 described below are executed as a result, when the program is executed by the processor 100c. Further, it can be said that these programs cause a computer to execute procedures or methods of the observation signal acquiring unit 101, the target sound vector selecting unit 103, the interference sound vector selecting unit 104, and the signal processing unit 105.

Here, the processor 100c is, for example, a CPU (Central Processing Unit), a processing device, an arithmetic device, a processor, a microprocessor, a microcomputer, or a DSP (Digital Signal Processor).

The memory 100d may be, for example, a nonvolatile or volatile semiconductor memory such as a random access memory (RAM), a (read only memory (ROM), a flash memory, an erasable programmable ROM (EPROM), or an electrically EPROM (EEPROM). It may be a hard disk, a magnetic disk such as a flexible disk, or an optical disk such as a mini disk, a compact disc (CD), or a digital versatile disc (DVD).

Note that some of the functions of the observation signal acquiring unit 101, the target sound vector selecting unit 103, the interference sound vector selecting unit 104, and the signal processing unit 105 may be implemented by dedicated hardware, and some of them may be implemented by software or firmware. As described above, the processing circuit 100b in the noise elimination device 100 can implement the above-described functions by hardware, software, firmware, or a combination thereof

Next, an operation of the noise elimination device 100 will be described.

FIG. 3 is a flowchart showing an operation of the signal processing unit 105 of the noise elimination device 100 according to the first embodiment.

In the flowchart of FIG. 3, it is assumed that positions of a target sound source and a noise source do not change while the noise elimination device 100 performs noise elimination processing and explained. In other words, it is assumed that a target sound steering vector and an interference sound steering vector do not change during performance of the noise elimination processing.

The signal processing unit 105 obtains a linear filter coefficient w(ω) from the target sound steering vector selected by the target sound vector selecting unit 103 and the interference sound steering vector selected by the interference sound vector selecting unit 104 (step ST1). The signal processing unit 105 accumulates observation signals input from the observation signal acquiring unit 101 in a temporary storage area (not shown) (step ST2).

The signal processing unit 105 determines whether or not the accumulated observation signals have a predetermined length (step ST3). If the accumulated observation signals do not have the predetermined length (step ST3; NO), the process returns to step ST2. On the other hand, if the accumulated observation signals have the predetermined length (step ST3; YES), the signal processing unit 105 performs discrete Fourier transform on the accumulated observation signals to obtain an observation signal vector x(ω, τ) (step ST4).

The signal processing unit 105 obtains a time-frequency spectrum Y(ω, τ) from the linear filter coefficient w(ω) obtained in step ST1 and the observation signal vector x(ω, τ) obtained in step ST4 (step ST5). The signal processing unit 105 performs discrete inverse Fourier transform on the time-frequency spectrum Y(ω, τ) obtained in step ST5 to obtain a time waveform (step ST6). The signal processing unit 105 outputs the time waveform obtained in step ST6 as an output signal to the external device 300 (step ST7), and the process ends.

As described above, according to the first embodiment, there is provided with: a target sound vector selecting unit 103 for selecting, from steering vectors acquired in advance and indicating arrival directions of sound with respect to a sensor array including two or more acoustic sensors, a target sound steering vector indicating an arrival direction of target sound; an interference sound vector selecting unit 104 for selecting, from the steering vectors acquired in advance, an interference sound steering vector indicating an arrival direction of interference sound other than the target sound; and a signal processing unit 105 for acquiring, on the basis of two or more observation signals obtained from the microphone array 200, the selected target sound steering vector, and the selected interference sound steering vector, a signal obtained by eliminating the interference sound from the observation signals. Therefore, using both the steering vector in the arrival direction of the target sound and the steering vector in the arrival direction of the interference sound, a gain of voice in the arrival direction of the target sound can be ensured, and a gain in the arrival direction of the interference sound can be reduced. As a result, compared to the noise elimination processing using only the steering vector in the arrival direction of the target sound, noise elimination performance when the arrival direction of the target sound and the arrival direction of the interference sound are close to each other can be improved, and a high-quality output signal can be obtained. In addition, since the steering vector in the arrival direction of the target sound and the steering vector in the arrival direction of the interference sound are given, there is no need to estimate a position of a sound source from the observation signals, and stable noise elimination performance can be obtained immediately after the start of the noise elimination processing.

Further, according to the first embodiment, since the signal processing unit 105 acquires the signal obtained by eliminating the interference sound from the observation signals by linear beamforming having a linear filter coefficient with the arrival direction of the target sound as a directivity formation direction and the arrival direction of the interference sound as a blind spot formation direction, an output signal with small distortion can be obtained by the linear beamforming, and a high-quality output signal can be obtained.

### Second Embodiment

In the first embodiment described above, the configuration in which the signal processing unit 105 is implemented by the method based on the linear beamforming has been described, but in this second embodiment, a configuration in which a signal processing unit 105 is implemented by a method based on nonlinear processing will be described. Here, the nonlinear processing is, for example, time-frequency masking.

Since a block diagram showing a configuration of a noise elimination device 100 according to the second embodiment is the same as that in first embodiment, description thereof is omitted. Further, components of the noise elimination device 100 according to the second embodiment will be described using the same reference numerals as those used in the first embodiment.

Hereinafter, description will be given of a configuration in which the signal processing unit 105 performs signal processing using time-frequency masking on the basis of similarity between an observation signal input from an observation signal acquiring unit 101 and a steering vector stored in a vector storage unit 102 measured in advance.

In the same manner as the processing of the linear beamforming described in the first embodiment, the signal processing unit 105 sets time-frequency spectra obtained by performing discrete Fourier transform on observation signals observed by M microphones to X₁(ω, τ) to X_{M}(ω, τ). When voice sparsity is established at this time, as shown in the following equation (10), the signal processing unit 105 obtains an estimation value â(ω, τ) of a steering vector of an observation signal by dividing and normalizing the observation signals by a time-frequency spectrum corresponding to the first microphone.

$$\hat{a} ( ω , τ ) = {( \begin{matrix}1 & \frac{{X}_{2} ( ω , τ )}{{X}_{1} ( ω , τ )} & ⋯ & \frac{{X}_{M} ( ω , τ )}{{X}_{1} ( ω , τ )}\end{matrix} )}^{T} \qquad ( 10 )$$

Under an ideal environment where the voice sparsity is completely established, when a spectrum of the observation signal in a time-frequency is target sound, the estimation value â(ω, τ) of the steering vector of the observation signal obtained on the basis of the above equation (10) agrees with a target sound steering vector a_{trg}(ω), and in a case of interference sound, the estimation value â(ω, τ) agrees with an interference sound steering vector a_{dst}(ω). This is because the target sound steering vector a_{trg}(ω) and the interference sound steering vector a_{dst}(ω) are normalized by the equation (1) described above in the same manner as the observation signals in the equation (10) described above.

Therefore, on the basis of agreement between the estimation value â(ω, τ) of the steering vector of the observation signal and either one of the target sound steering vector a_{trg}(ω) and the interference sound steering vector a_{dst}(ω), the signal processing unit 105 can generate an optimum time-frequency mask.

However, practically, an error is included in the estimation value â(ω, τ) of the steering vector of the observation signal. Accordingly, the signal processing unit 105 can obtain stable noise elimination performance by generating a time-frequency mask on the basis of a similarity between the estimation value â(ω, τ) of the steering vector of the observation signal and either one of the target sound steering vector a_{trg}(ω) and the interference sound steering vector a_{dst}(ω). In the signal processing unit 105, the estimation value â(ω, τ) of the steering vector of the observation signal calculates a similarity between the target sound steering vector a_{trg}(ω) and the interference sound steering vector a_{dst}(ω). When a steering vector having the maximum calculated similarity is the target sound steering vector a_{trg}(ω), the signal processing unit 105 allows a time-frequency spectrum of the observation signal to pass. On the other hand, when the steering vector having the maximum calculated similarity is the interference sound steering vector a_{dst}(ω), the signal processing unit 105 blocks the time-frequency spectrum of the observation signal.

Specifically, when a time-frequency mask for allowing only the target sound to pass is B(ω, τ), the signal processing unit 105 generates a time-frequency mask B(ω, τ) on the basis of a distance between the steering vectors as shown in the following equation (11).

$$B ( ω , τ ) = \{ \begin{matrix}1 & ( \vert \vert {a}_{trg} ( ω ) - \hat{a} ( ω , τ ) \vert \vert < \vert \vert {a}_{dst} ( ω ) - \hat{a} ( ω , τ ) \vert \vert ) \\ 0 & ( otherwise )\end{matrix} \qquad ( 11 )$$

According to the equation (11), the time-frequency mask B(ω, τ) allows only a time-frequency spectrum of the target sound to pass and blocks a time-frequency spectrum other than the target sound.

Using the time-frequency mask B(ω, τ), the signal processing unit 105 obtains a time-frequency spectrum Y(ω, τ) of an output signal on the basis of the following equation (12).

Y(ω, τ)=B(ω, τ)X₁(ω, τ) (12)

The signal processing unit 105 performs discrete inverse Fourier transform on the obtained time-frequency spectrum Y(ω, τ), reconstructs a time waveform, and generates an output signal. The signal processing unit 105 outputs the generated output signal to an external device 300.

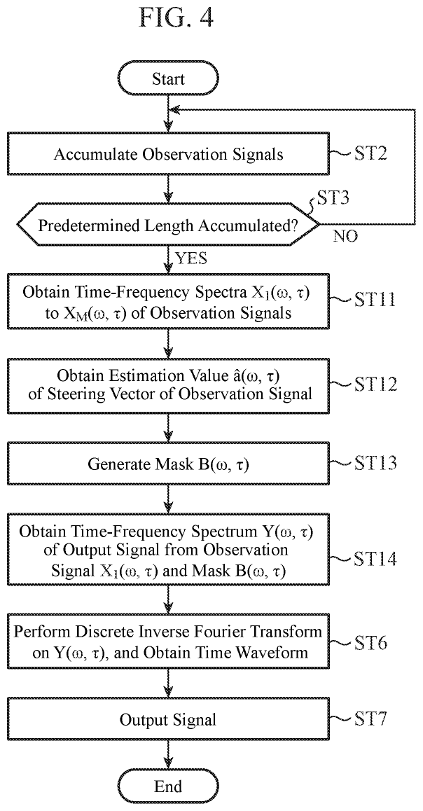

FIG. 4 is a flowchart showing an operation of the signal processing unit 105 of the noise elimination device 100 according to the second embodiment.

As a prerequisite for performing processing shown in the flowchart of FIG. 4, it is assumed that a target sound steering vector and an interference sound steering vector do not change while the noise elimination device 100 performs noise elimination processing.

Note that, in the following, the same steps as those of the noise elimination device 100 according to the first embodiment are denoted by the same reference numerals as those used in FIG. 3, and description thereof is omitted or simplified.

The signal processing unit 105 accumulates observation signals input from the observation signal acquiring unit 101 in a temporary storage area (not shown) (step ST2). The signal processing unit 105 determines whether or not the accumulated observation signals have a predetermined length (step ST3). If the accumulated observation signals do not have the predetermined length (step ST3; NO), the process returns to step ST2. On the other hand, if the accumulated observation signals have the predetermined length (step ST3; YES), the signal processing unit 105 performs discrete Fourier transform on the accumulated observation signals to obtain time-frequency spectra X₁(ω, τ) to X_{M}(ω, τ) of the observation signals (step ST11). The signal processing unit 105 obtains an estimation value â(ω, τ) of a steering vector of an observation signal from the time-frequency spectra X₁(ω, τ) to X_{M}(ω, τ) of the observation signals obtained in step ST11 (step ST12).

The signal processing unit 105 generates a mask on the basis of a distance between the estimation value â(ω, τ) of the steering vector of the observation signal obtained in step ST12 and a target sound steering vector a_{trg}(ω) and a distance between the estimation value â(ω, τ) of the steering vector of the observation signal and an interference sound steering vector a_{dst}(ω) (step ST13). Describing processing in step ST13 in detail, the signal processing unit 105 generates a time-frequency mask B(ω, τ) that becomes “1” in a time-frequency in which the distance between the estimation value â(ω, τ) of the steering vector of the observation signal and the target sound steering vector a_{trg}(ω) is smaller than the distance between the estimation value â(ω, τ) of the steering vector of the observation signal and the interference sound steering vector a_{dst}(ω), and generates a time-frequency mask B(ω, τ) that becomes “0” in the other time-frequency.

The signal processing unit 105 obtains a time-frequency spectrum Y(ω, τ) of an output signal from the time-frequency spectrum X₁(ω, τ) of the observation signal obtained in step ST11 and the mask generated in step ST13 (step ST14). The signal processing unit 105 performs discrete inverse Fourier transform on the time-frequency spectrum Y(ω, τ) obtained in step ST14 to obtain a time waveform (step ST6). The signal processing unit 105 outputs the time waveform obtained in step ST6 as an output signal to the external device 300 (step ST7), and the process ends.

As described above, according to the second embodiment, since the signal processing unit 105 acquires a signal obtained by eliminating the interference sound from the observation signals by time-frequency masking using a mask that blocks a time-frequency spectrum of the interference sound, there is no restriction that the number of steering vectors to be extracted or eliminated simultaneously must be equal to or less than the number of microphones, and it can be used in a wide range of situations. In addition, noise elimination performance higher than that in the linear beamforming can be obtained.

Further, according to the second embodiment, in the time-frequency masking, a steering vector for each time-frequency is estimated from the two or more observation signals, and a similarity between the estimated steering vector of the observation signal and the target sound steering vector and the interference sound steering vector is calculated. When the steering vector having the maximum calculated similarity is the target sound steering vector, a time-frequency spectrum of the observation signal is allowed to pass, and when the steering vector having the maximum calculated similarity is not the target sound steering vector, a time-frequency spectrum of the observation signal is blocked. Therefore, since not only a time difference of voice observed by the microphone array but also an amplitude difference is considered simultaneously, it is possible to generate a more accurate time-frequency mask. Thereby, high noise elimination performance can be obtained.

The noise elimination device 100 described in the first embodiment or the second embodiment can be applied to a recording system, a hands-free call system, a voice recognition system, or the like.

First, a case where the noise elimination device 100 described in the first embodiment or the second embodiment is applied to a recording system will be described.

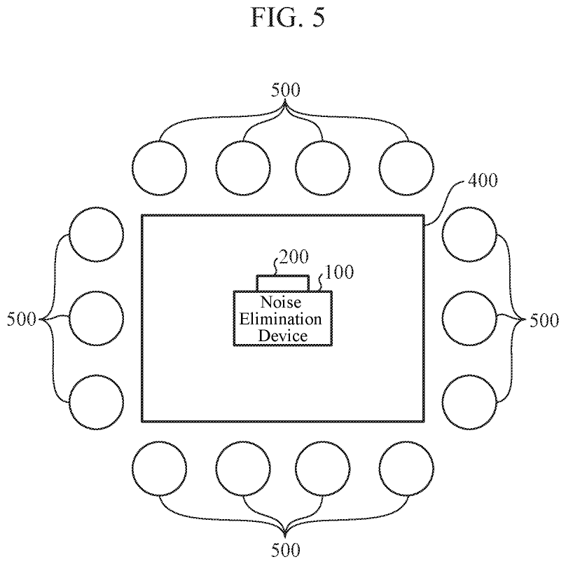

FIG. 5 is a diagram illustrating an application example of the noise elimination device 100 according to the first embodiment or the second embodiment. FIG. 5 shows a case where the noise elimination device 100 is applied to a recording system that records voice in a conference, for example.

As shown in FIG. 5, the noise elimination device 100 is disposed on a conference desk 400. Conference participants sit on a plurality of chairs 500 disposed around the conference desk 400. It is assumed that the vector storage unit 102 of the noise elimination device 100 stores in advance a result obtained by measuring a steering vector corresponding to an arrangement direction of each chair 500 viewed from the microphone array 200 connected to the noise elimination device 100.

When utterance of each conference participant is extracted individually, the target sound vector selecting unit 103 selects the steering vector corresponding to the arrangement direction of each chair 500 as a target sound steering vector. On the other hand, the interference sound vector selecting unit 104 selects a steering vector corresponding to a direction other than the chair 500 described above as an interference sound steering vector.

When the conference in which the conference participants sit on the chairs 500 is started, the microphone array 200 collects voices of the conference participants and outputs them to the noise elimination device 100 as observation signals. The observation signal acquiring unit 101 of the noise elimination device 100 converts the input observation signals into digital signals and outputs the digital signals to the signal processing unit 105. By using the observation signals input from the observation signal acquiring unit 101, the target sound steering vector selected by the target sound vector selecting unit 103, and the interference sound steering vector selected by the interference sound vector selecting unit 104, the signal processing unit 105 extracts individual utterance of the conference participants. The external device 300 records voice signals of the individual utterance of the conference participants extracted by the signal processing unit 105. Thus, for example, minutes can be easily created using the recording system.

On the other hand, when only utterance of a certain conference participant is extracted, the target sound vector selecting unit 103 selects a steering vector corresponding to an arrangement direction of the chair 500 of the conference participant, from which the utterance is extracted, as the target sound steering vector. On the other hand, the interference sound vector selecting unit 104 selects a steering vector corresponding to a direction other than the above-described conference participant as the interference sound steering vector.

When the conference participants sit on the chairs 500 and the conference is started, the microphone array 200 collects utterance of the conference participants and outputs them to the noise elimination device 100 as observation signals. The observation signal acquiring unit 101 of the noise elimination device 100 converts the input observation signals into digital signals and outputs the digital signals to the signal processing unit 105. By using the observation signals input from the observation signal acquiring unit 101, the target sound steering vector selected by the target sound vector selecting unit 103, and the interference sound steering vector selected by the interference sound vector selecting unit 104, the signal processing unit 105 extracts only the utterance of the certain conference participant. The external device 300 records a voice signal of the utterance of the certain conference participant extracted by the signal processing unit 105.

As described above, on the premise that speaker units sit on the chairs 500, by measuring in advance the steering vectors corresponding to the directions of the chairs 500, utterance of the speaker units sit on the chairs 500 can be extracted or eliminated with high accuracy.

Next, a case where the noise elimination device 100 shown in the first embodiment or the second embodiment is applied to a hands-free call system or a voice recognition system will be described.

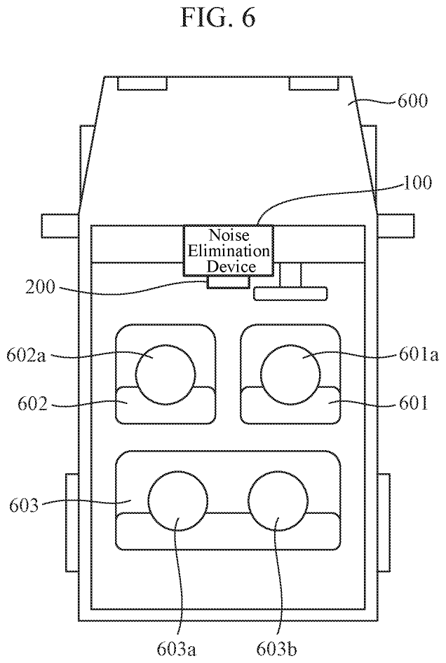

FIG. 6 is a diagram illustrating an application example of the noise elimination device 100 according to the first embodiment or the second embodiment. FIG. 6 shows a case where the noise elimination device 100 is applied to a hands-free call system or a voice recognition system in a vehicle. The noise elimination device 100 is disposed, for example, in front of a vehicle 600, that is, in front of the vehicle 600 with respect to a driver seat 601 and a passenger seat 602.

A driver 601a of the vehicle 600 sits on the driver seat 601. Other occupants 602a, 603a, and 603b of the vehicle 600 sit on the passenger seat 602 and rear seats 603. The noise elimination device 100 collects utterance of the driver 601a sit on the driver seat 601 and performs noise elimination processing for hands-free call or noise elimination processing for voice recognition. In order for the driver 601a to make a hands-free call or in order to perform voice recognition of voice of the driver 601a, it is necessary to eliminate various noises mixed in the utterance of the driver 601a. For example, voice uttered by the occupant 602a seated in the passenger seat 602 becomes noise to be eliminated when the driver 601a speaks.

It is assumed that the vector storage unit 102 of the noise elimination device 100 stores in advance results obtained by measuring steering vectors corresponding to directions of the driver seat 601 and the passenger seat 602 viewed from the microphone array 200 connected to the noise elimination device 100. Next, when only the utterance of the driver 601a seated in the driver seat 601 is extracted, the target sound vector selecting unit 103 selects the steering vector corresponding to the direction of the driver seat 601 as a target sound steering vector. On the other hand, the interference sound vector selecting unit 104 selects the steering vector corresponding to the direction of the passenger seat 602 as an interference sound steering vector.

When the driver 601a and the occupant 602a speak, the microphone array 200 collects voice of the driver 601a and outputs it to the noise elimination device 100 as an observation signal. The observation signal acquiring unit 101 of the noise elimination device 100 converts the input observation signal into a digital signal and outputs the digital signal to the signal processing unit 105. By using the observation signal input from the observation signal acquiring unit 101, the target sound steering vector selected by the target sound vector selecting unit 103, and the interference sound steering vector selected by the interference sound vector selecting unit 104, the signal processing unit 105 extracts individual utterance of the driver 601a. The external device 300 accumulates voice signals of the individual utterance of the driver 601a extracted by the signal processing unit 105. The hands-free call system or the voice recognition system executes voice call processing or voice recognition processing by using the voice signals accumulated in the external device 300. As a result, the voice call processing or the voice recognition processing can be performed by eliminating voice uttered by the occupant 602a seated in the passenger seat 602 and extracting only the utterance of the driver 601a with high accuracy.

Note that, in the above description, the voice uttered by the occupant 602a seated in the passenger seat 602 has been described as an example of noise to be eliminated when the driver 601a speaks. However, in addition to the passenger seat 602, voice uttered by the occupants 603a, 603b seated in the rear seats 603 may be eliminated as noise.

As described above, by measuring in advance the steering vectors corresponding to the directions of the driver seat 601, the passenger seat 602, and the rear seats 603 of the vehicle 600, the utterance of the driver 601a seated in the driver seat 601 can be accurately extracted. Thereby, in the hands-free call system, call sound quality can be improved. In addition, in the voice recognition system, the driver's utterance can be recognized with high accuracy even in the presence of noise.

Other than those described above, the present invention can freely combine embodiments, modify arbitrary components in the embodiments, or omit arbitrary components in the embodiments within the scope of the invention.

### INDUSTRIAL APPLICABILITY

The noise elimination device according to the present invention is a device used in an environment where noise other than a target sound is generated, and can be applied to a recording device, a call device, or a voice recognition device for collecting only the target sound.

### REFERENCE SIGNS LIST

100: noise elimination device,
101: observation signal acquiring unit,
102: vector storage unit,
103: target sound vector selecting unit,
104: interference sound vector selecting unit, and
105: signal processing unit.

1. A noise elimination device comprising: processing circuitry
to select, from steering vectors acquired in advance and indicating arrival directions of sound with respect to a sensor array including two or more acoustic sensors, a target sound steering vector indicating an arrival direction of a target sound;
to select, from the steering vectors acquired in advance, an interference sound steering vector indicating an arrival direction of interference sound other than the target sound; and
to acquire, on a basis of two or more observation signals obtained from the sensor array, the selected target sound steering vector, and the selected interference sound steering vector, a signal obtained by eliminating the interference sound from the observation signals.

2. The noise elimination device according to claim 1, wherein
by linear beamforming having a linear filter coefficient with the arrival direction of the target sound as a directivity formation direction and the arrival direction of the interference sound as a blind spot formation direction, the processing circuitry acquires a signal obtained by eliminating the interference sound from the observation signals.

3. The noise elimination device according to claim 1, wherein
by time-frequency masking using a mask for blocking a time-frequency spectrum of the interference sound, the processing circuitry acquires a signal obtained by eliminating the interference sound from the observation signals.

4. The noise elimination device according to claim 3, wherein
in the time-frequency masking, a steering vector for each time-frequency is estimated from the two or more observation signals, and a similarity between a steering vector of the estimated observation signal and the target sound steering vector and the interference sound steering vector are calculated, and when the steering vector having the maximum calculated similarity is the target sound steering vector, a time-frequency spectrum of the observation signal is allowed to pass, and when the steering vector having the maximum calculated similarity is not the target sound steering vector, a time-frequency spectrum of the observation signal is blocked.

5. The noise elimination device according to claim 1, wherein the processing circuitry has stored therein the steering vectors acquired in advance and indicating the arrival directions of the sound.

6. The noise elimination device according to claim 1, wherein the steering vectors acquired in advance and indicating the arrival directions of the sound are steering vectors indicating arrival directions of sound from positions estimated to be seated by users to the sensor array.

7. The noise elimination device according to claim 6, wherein
the processing circuitry extracts or eliminates voice of the users seated at the positions estimated to be seated from the observation signals.

8. The noise elimination device according to claim 1, wherein
the steering vectors acquired in advance and indicating the arrival directions of the sound are steering vectors indicating arrival directions of sound from a driver seat and a passenger seat in a vehicle to the sensor array.

9. The noise elimination device according to claim 8, wherein
the processing circuitry extracts or eliminates voice of a user seated in the driver seat or the passenger seat from the observation signals.

10. A noise elimination method comprising:
selecting, from steering vectors acquired in advance and indicating arrival directions of sound with respect to a sensor array including two or more acoustic sensors, a target sound steering vector indicating an arrival direction of target sound;
selecting, from the steering vectors acquired in advance, an interference sound steering vector indicating an arrival direction of interference sound other than the target sound; and
acquiring, on a basis of two or more observation signals obtained from the sensor array, the selected target sound steering vector, and the selected interference sound steering vector, a signal obtained by eliminating the interference sound from the observation signals.
